(19) United States
(12) Patent Application Publication
(10) Pub. No.: US 2012/0102030 A1
(43) Pub. Date: Apr. 26, 2012

(54) Methods for text conversion, search, and automated translation and vocalization of the text

(76) Inventors: Andrei Yoryevich Sherbakov, Moscow (RU); Sergey Valentinovich Malahov, Ghukovskyi (RU); Aleksey Vasilyevich Chugrinov, Moscow (RU); Marat Ramilyevich Biktimirov, Moscow (RU); Dmitry Igorevich Pravikov, Moscow (RU)

(21) Appl. No.: 13/317,480

(22) Filed: Oct. 19, 2011

(30) Foreign Application Priority Data
Oct. 25, 2010 (EA) EAPO 201001550

(51) Int. Cl. G06F 17/30; G06F 17/28; G06F 17/21

(52) U.S. Cl. 707/736; 704/10; 704/2; 707/E17.058

(57) ABSTRACT

Methods for conversion, search, automated translation, and vocalization of text are proposed. A method for converting text (including also computer programs) includes—dividing the text into words,—converting the words into a digital representation with a fixed length,—composing a vocabulary containing the words at least once occurring in the text and/or the digital representations thereof, and—storing the digital representations and/or the vocabulary with or instead of the text. Another method for text automated translation into a language further includes—substituting the words in the vocabulary and/or in the words' digital representations by digital representations of words with similar meaning in the language, or immediately by identical words of the language. Another method for text vocalization further includes—generating sounds respectively to the digital representation of each text's word providing reproduction of the whole word. Additional embodiments provide for effective search, enhanced memory usage, storing certain word characteristics, etc.

### CROSS-REFERENCE TO RELATED APPLICATION

This U.S. patent application claims priority under 35 U.S.C. 119 (a) through (d) from a Eurasian patent application EAPO 201001550 filed on 25 Oct. 2010.

### FIELD OF THE INVENTION

The invention relates to information technology, specifically to methods of text conversion, search, automated translation, and automated vocalization of the text. The present invention can find useful applications in the fields of development and maintenance of computer systems of various kinds usable in different industries, wherein there is a need in search and analysis of information derived from a variety of sources, e.g. in medicine, science, and education.

### BACKGROUND AND OBJECTS OF THE INVENTION

Nowadays, there are available a multitude of various search engines capable of executing a search according to comparatively complicated requests entered in a natural language. A major and significant problem however waits for solutions, which problem can be formulated as follows: how to effectively process and analyze the search results and subsequently utilize such results. Particularly, many Internet-found references may essentially coincide, and the search results thus need additional processing with the purpose of identifying the meaning of the results, translation of the results into other languages, and other analytical operations, including vocalization of the results.

The primary object of the present invention is the creation of methods for conversion of text, search, automated translation and vocalization of text, which methods should provide universal and uniform compact storage of the text, searching for complex word constructions, translation of the text into other languages, and vocalization of the text with high quality.

The related art includes U.S. Pat. No. 7,260,573 ‘Personalizing anchor text scores in a search engine’ and U.S. Pat. No. 6,636,848 ‘Information search using knowledge agents’, which deal with the problem.

Besides, U.S. Pat. No. 7,010,526 teaches ‘Knowledge-based data mining system’ wherein ‘data is gathered into a data store using, e.g., a Web crawler. The data is classified into entities. Data miners use rules to process the entities and append respective keys to the entities representing characteristics of the entities as derived from expert rules embodied in the miners. With these keys, characteristics of entities as defined by disparate expert authors of the data miners are identified for use in responding to complex data requests from customers.’ Therefore, ‘Web crawling’ is a process of building a list of words found on a Web page.

The results of processing the entire amount of Web pages, available for the Web crawling, are transformed according to the predetermined algorithmic expert rules and placed into the knowledge base. The subsequent user requests are processed, however, within this particular knowledge base, but not within the entire information cyberspace of Internet, which narrows its usability. The most frequent application of such solution, described in the U.S. Pat. No. 7,010,526, is blocking access to porno information that is automatically excluded from the knowledge base by the expert rules.

U.S. Pat. No. 6,128,624 ‘Collection and integration of internet and electronic commerce data in a database during web browsing’ discloses a system that collects information from two sources: Internet provider and e-commerce provider. Particularly, the first source includes Web log data that contain information on the websites previously visited by the user. This information is used for an individual approach to the user needs in terms of running a Web business (direct marketing) and during development of Web-oriented applications.

The aforementioned related art methods don't fully solve the above-formulated problem of the present invention and don't provide universal and uniform compact storage of the text, searching for complex word constructions, translation of the text into other languages, and vocalization of the text with high quality.

### SUMMARY OF THE INVENTION

The inventive methods allow eliminating the drawbacks of aforementioned related art methods, and attaining the above-stated object. Accordingly, in a preferred embodiment, a first inventive method for converting an initial text comprises the steps of:—dividing the initial text into a plurality of words;—converting each word of at least a portion of the plurality of words into a corresponding digital representation with a fixed length;—composing a vocabulary of the words, wherein the vocabulary contains the words at least once occurring in the initial text, and/or the digital representations thereof;—the digital representations and the vocabulary are stored with the initial text or instead of the initial text.

It should be noted that the conversion of a portion of the text's words into their digital representation is justified only when the converted text is a standardized text, such as: letters, receipts, contracts, etc.

A second object of the present invention is to propose a second inventive method for searching text converted according to the above described first text conversion method. In a preferred embodiment, the second inventive method comprises the steps of:—composing a predetermined search request consisting of a number of words;—providing a search by converting at least a portion of the number of words of aforesaid search request into their digital representations;—determining the presence of the words of aforesaid search request in the vocabulary;—if the words of aforesaid search request are present in the vocabulary, (a) conducting the search of the digital representation of the words of aforesaid search request among the digital representations of the words of the initial text, or/and (b) conducting the search of the words of aforesaid search request among the words of the initial text.

A third object of the present invention is to propose a third inventive method for automated translation of the text into a predetermined language, comprising the steps of:—converting the words of the text into their digital representations and forming the vocabulary, as described above;—substituting the words in the vocabulary and/or in the digital representation of the words of aforesaid text by digital representations of words with a similar meaning in the predetermined language or immediately by the identical words in the predetermined language.

A fourth object of the present invention is to propose a fourth inventive method for vocalization of the text converted into the digital representation as described above, wherein the method comprises the step of:—generating audio signals respectively to the digital representation of each word of the text, wherein the digital representation provides reproduction of the whole word, versus reproduction of the word by syllables that enhances the quality of vocalization.

The proposed methods solve the above-stated problem of the instant invention, and present a novel universal way of architectural solution, since all the inventive methods employ the same type of text conversion.

When operating on at least two texts, before the conversion of the texts into the digital representation, it is preferable to format the texts into a single symbol encoding. This provides a standardizing and unification of the technological solutions for implementation of the claimed methods.

For the conversion of the texts into the digital representation, it is considered reasonable to use a hash function with a length of hash value less than the average length of the text's words, which provides compact storage of the digital representation.

In the addendums 1, 2, and 3 herein below, there are provided examples of utilization of a hash function having the hash value equal to 3, wherein the average length of words in the text written in Russian is about 6 letters, which provides (also taking into account the spaces between the words) an almost double saving for storage of information.

During the conversion of the text into its digital representation, it also advisable additionally allocating and storing, without limitation, the following characteristics of each word of the text: an initial form and/or basis of, grammar forms, emphasis, synonyms, relation of the words to a knowledge field, emotional background, presence of the words in idioms, and usage thereof, which are important for the search, translation, vocalization of the text, and other operations thereon.

While carrying out the search method, during the composing or/and the execution of a search request, it is reasonable to assure the spelling of the request's words and the presence of the request's words in a predetermined set of words.

While carrying out the translation method, it is preferable to employ the digital representation of words of the text as an address of associative memory, and to store characteristics of each word of the text in the associative memory. The following characteristics, without limitations, may be stored in the associative memory: an initial form and/or basis of a predetermined word, grammar forms of the word, emphasis, synonyms, relation of such predetermined word to a knowledge field, emotional background, presence of such predetermined word in idioms, usage of such predetermined word.

It is important for programming and testing computer programs to implement the inventive methods for the texts being initial texts for the computer programs. For instance, the conversion of the initial texts into the digital representation allows uncovering a majority of deficiencies and errors in the computer program, such as the absence of paired commands, e.g. ‘open the file—close the file’ or ‘allocate the memory unit—free the memory unit’, since an uncompleted paired command is easy to notice in the vocabulary.

For accomplishing an accelerated processing for conversion, search, translation, and vocalization of the text, it is preferable to deploy a special computing apparatus for computation of the digital representation of the text.

It is advisable to employ the inventive method for vocalization for, without limitation, electronic books, mobile device messages, messages of PC and mobile computing devices, navigation systems, which significantly improves services and convenience for the users.

### BRIEF DESCRIPTION OF DRAWING

FIG. 1 illustrates Addendum 1 demonstrating an example of text conversion according to the present invention.

FIG. 1a illustrates a continuation of Addendum 1 demonstrating an example of text conversion according to the present invention.

FIG. 2 illustrates Addendum 2 demonstrating an example of implementation the inventive method.

FIG. 3 illustrates Addendum 2 demonstrating an example of implementation the inventive method.

FIG. 4 illustrates a block diagram for implementation of text conversion, according to a preferred embodiment of the present invention.

### DETAIL DESCRIPTION OF PREFERRED EMBODIMENT OF THE INVENTION

While the invention may be susceptible to embodiment in different forms, there are shown in the drawings, and will be described in detail herein, specific embodiments of the present invention, with the understanding that the present disclosure is to be considered an exemplification of the principles of the invention, and is not intended to limit the invention to that as illustrated and described herein.

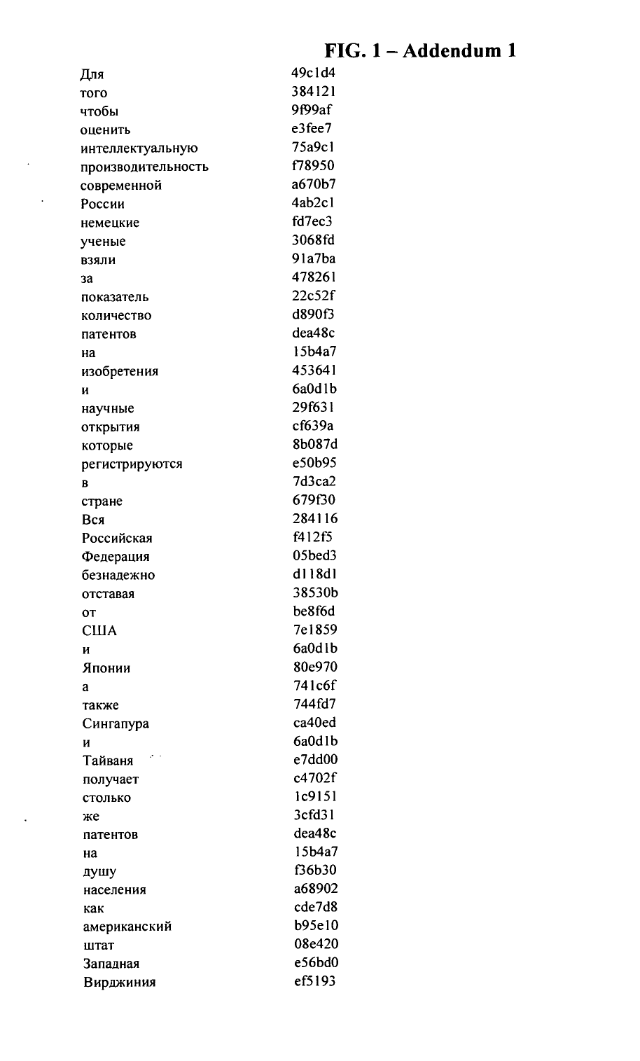

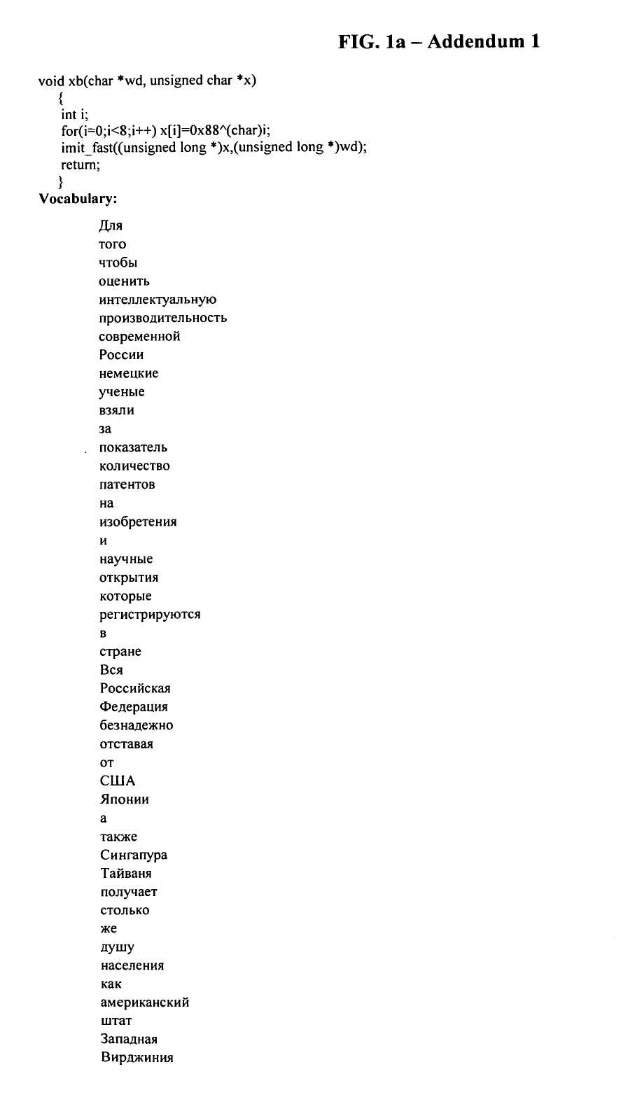

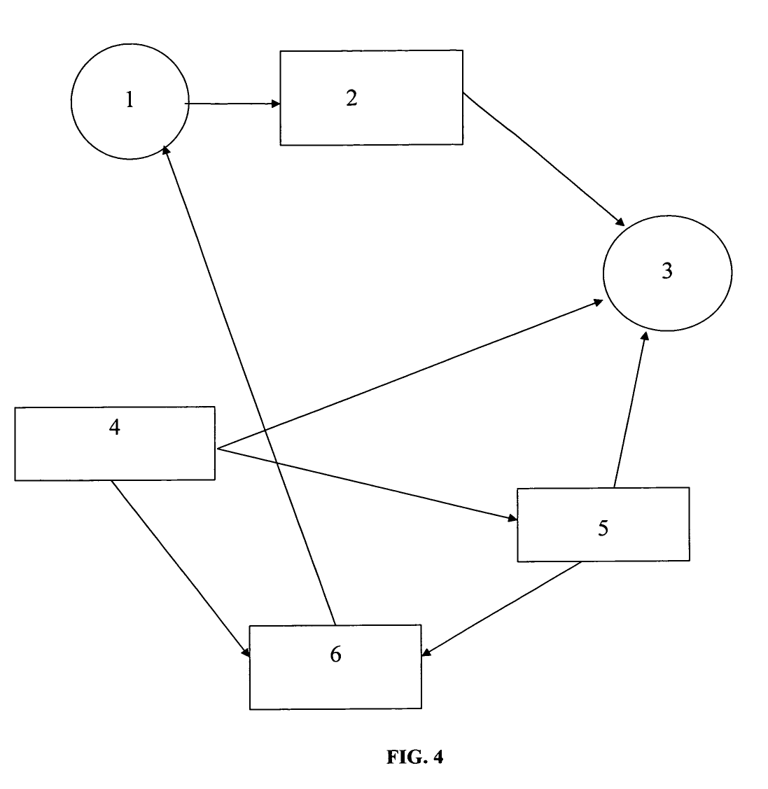

The present invention is disclosed in detail in an exemplary preferred embodiment described herein below. It is referred to FIG. 4 that schematically illustrates a block diagram for a system of analytical processing information. Exemplarily, the system implements the inventive method for text conversion according to the preferred embodiment of the present invention that is reflected in Addendum 1 (FIGS. 1 and la) attached hereto.

The system depicted on FIG. 4 comprises: an information source 1 (e.g. a search engine); a unit 2 for conversion of texts found during a search into the digital representation, a storage device 3 for storing digital representations; a unit 4 for additional search and comparing texts in the digital representation; a translation unit 5; and a user 6 receiving information from the system.

The system shown on FIG. 4 operates in the following order: the user 6 formulates a request and enters it into the information source 1, from which source the system obtains results of the request, directs the results into the unit 2, and, after the conversion of the results into the digital representation, saves the converted text results to the storage device 3, wherein they are stored.

The unit 4 carries out a comparison and/or search of the digital representations accumulated in the storage device 3. The translation unit 5 automatically translates the text utilizing the digital representation of words thereof, as described above. The translation results are saved to the storage device 3 and provided to the user 6.

Addendum 1 is illustrated on FIGS. 1 and 1a. It exemplifies a procedure xb of conversion of a word wd into a digital representation x. Function imit_fast corresponds to one iteration of a cryptographic transformation described in GOST 28147-89. Addendum 1 illustrates an exemplary conversion of each word of the text shown thereon into the digital representation based on the aforesaid cryptographic transformation, as well as an example of vocabulary for the text.

It can be noticed from FIGS. 1 and 1a that the digital representations with the length of 6 hexadecimal digits and 3 bytes for different words are distinct, whereas for identical words are coincided.

The procedure of comparison of the texts is very important for semantic identification of the texts. For the related art, this problem presents a challenge, since it is necessary to perform a sequential word-by-word comparison of different text pairs, which is a complicated computation task. The proposed inventive method allows substantial simplifying the comparison, and therefore facilitates and improves identifying the semantic meaning of the texts.

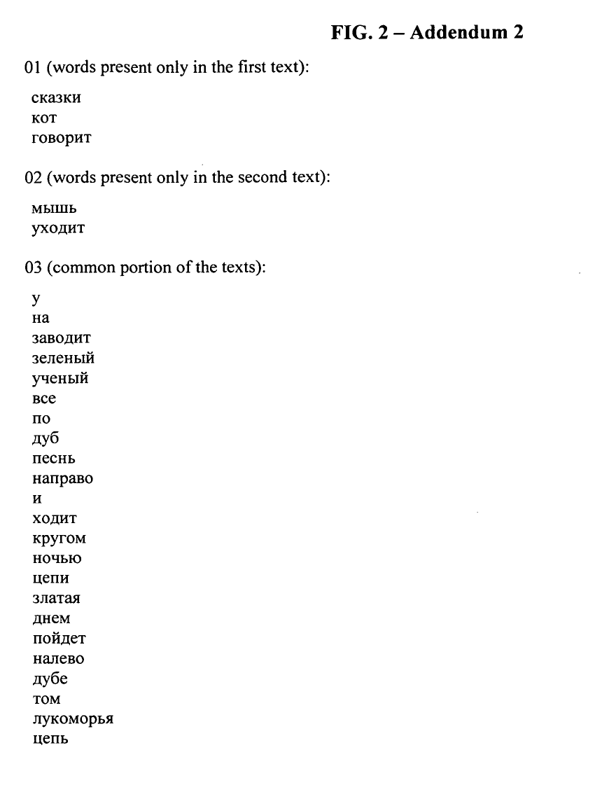

Addendum 2 (FIG. 2) illustrates a result of comparison of the two texts, carried out utilizing the inventive methods. For the text pair, based on their digital representation, three objects are formed: object 01 encompassing the words occurring in the first text only; object 02 encompassing the words occurring in the second text only; and object 03 encompassing the words occurring in the first text and in the second text (common words). Therefore, when one compares an arbitrary text with a thematic text (i.e. a vocabulary of certain knowledge field), then object 01 can represent novelty, object 02 can represent underused notions of the theme, and object 03 can represent an extent of approximation of the object to the theme.

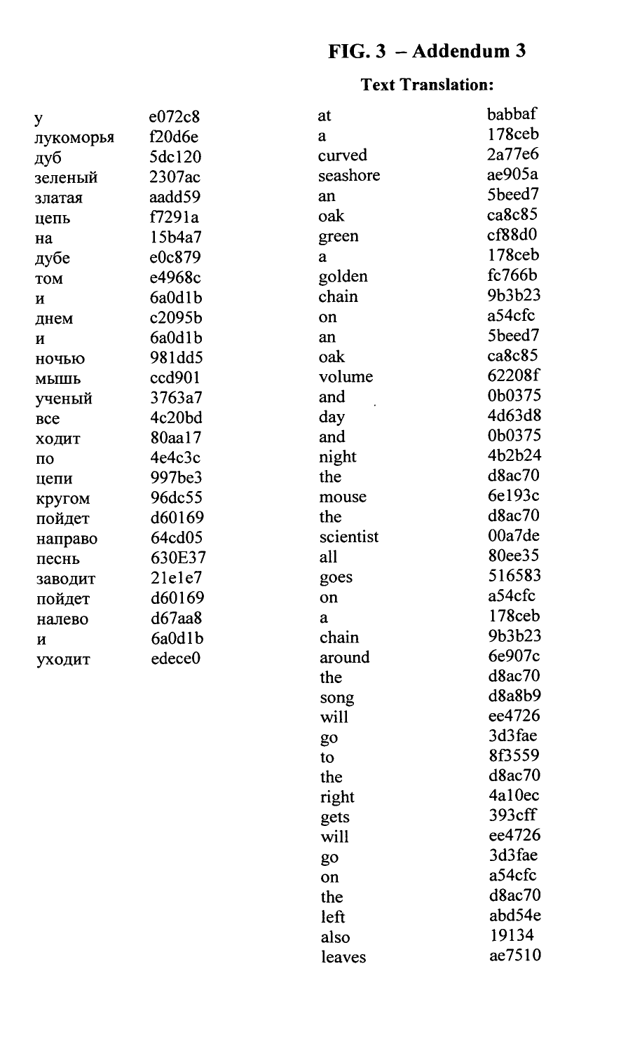

Addendum 3 (FIG. 3) illustrates a translation of a Russian text into English by using an automated comparison of digital representations of corresponding words in Russian and English, according to the inventive methods. It's worth to note that the described translation method can be modified to provide a self-learning mode, wherein digital representations for identical text pairs in different languages can be compared, whereas the translation procedure is not tied to a particular language.

Besides, according to a preferred embodiment of the present invention, the translation can be carried out taking into account, without limitation, the following word features: an initial form and/or basis of the word, grammar forms of the word, emphasis, synonyms, relation of the word to a knowledge field, emotional background, presence of the word in idioms, usage of the word, which can significantly improve the quality of translation.

As opposed to the technological solutions of known related art, the present invention allows providing a universal and unified compact storage for texts, search for complex word combinations, translation of texts into other languages, and a high quality vocalization of texts.

We claim:

1. A method for converting at least one initial text comprising the steps of:
dividing said initial text into a plurality of words;
converting each word of at least a portion of the plurality of words into a corresponding digital representation with a fixed length;
composing a vocabulary containing the words at least once occurring in said initial text, and/or the digital representations thereof; and
storing the digital representations and/or the vocabulary with said initial text or instead of said initial text.

2. The method according claim 1, wherein said initial text is represented by at least two different text pieces, and the method further comprises the step of:
formatting said text pieces into a single symbol encoding before the dividing of each said text piece into a plurality of words.

3. The method according claim 1, further comprising the steps of:
calculating an average length of the text's words; and
using a hash function with a length of hash value less than said average length.

4. The method according claim 1, further comprising the step of
allocating and storing the following characteristics of each word of the text: an initial form and/or basis of, grammar forms, emphasis, synonyms, relation of the words to a knowledge field, emotional background, presence of the words in idioms, and usage thereof.

5. The method according claim 1, wherein said initial text is represented by text of a computer program.

6. The method according claim 1, further comprising the steps of:
composing a predetermined search request consisting of a number of words;
providing a search by converting at least a portion of the number of words of said search request into their digital representations;
determining the presence of the words of said search request in said vocabulary; and
if the words of said search request are present in the vocabulary, (a) conducting the search of the digital representation of the words of said search request among the digital representations of the words of said initial text, or/and (b) conducting the search of the words of said search request among the words of said initial text.

7. The method according claim 6, further comprising the step of:
during said composing and/or said conducting the search, assuring
the spelling of the words of said search request, and
the presence of the words of said search request in a predetermined set of words.

8. The method according claim 1, further used for automated translation of said text into a predetermined language, said method further comprising the step of:
substituting the words in said vocabulary and/or in the digital representation of the words of said text by digital representations of words with a similar meaning in the predetermined language, or immediately by words identical to the words of said vocabulary in the predetermined language.

9. The method according claim 8, further comprising the steps of:
employing the digital representation of predetermined words of said text as addresses of associative memory; and
storing in the associated memory the following characteristics of each of the predetermined words of said text: an initial form and/or basis of the predetermined word, grammar forms of the predetermined word, emphasis of the predetermined word, synonyms of the predetermined word, relation of the predetermined word to a knowledge field, emotional background of the predetermined word, presence of the predetermined word in idioms, and usage of the predetermined word.

10. The method according claim 1, further comprising the step of:
deploying a dedicated computer for computation of the digital representation of said initial text.

11. The method according claim 1, further used for vocalization of said initial text; said method further comprising the step of:
generating audio signals respectively to the digital representation of each word of said initial text, wherein the digital representation of each word of said initial text provides reproduction of the whole word.

12. The method according claim 11, wherein said method is employed for vocalization of electronic books, mobile device messages, messages of PC and mobile computing devices, and navigation systems.
